(19) United States
(12) Patent Application Publication
(10) Pub. No.: US 2021/0032484 A1
(43) Pub. Date: Feb. 4, 2021

(54) INKJET INK AND INKJET RECORDING SYSTEM

(71) Applicant: KYOCERA Document Solutions Inc., Osaka (JP)

(72) Inventor: Noriaki OZAWA, Osaka-shi (JP)

(73) Assignee: KYOCERA Document Solutions Inc., Osaka (JP)

(21) Appl. No.: 16/940,905

(22) Filed: Jul. 28, 2020

(30) Foreign Application Priority Data
Jul. 30, 2019 (JP) 2019-139863

(51) Int. Cl. C09D 11/322; C09D 11/107; C08L 25/08; C08L 33/02; C08L 33/08; C08L 33/10; C08L 23/06; C08K 5/053

(52) U.S. Cl. CPC C09D 11/322; C09D 11/107; C08L 25/08; C08L 33/02; C08K 2201/003; C08L 33/10; C08L 23/06; C08K 5/053; C08L 2205/02; C08L 33/08

(57) ABSTRACT

An inkjet ink contains pigment particles, resin particles, wax particles, water, and an α, ω-alkanediol having a carbon number of at least 3 and no greater than 5. The resin particles contain a resin including a styrene unit. A ratio of the styrene unit to all repeating units included in the resin is at least 27% by mass and no greater than 75% by mass. The wax particles contain a polyethylene resin. The wax particles have a volume median diameter of at least 20 nm and no greater than 100 nm.

### INCORPORATION BY REFERENCE

The present application claims priority under 35 U.S.C. § 119 to Japanese Patent Application No. 2019-139863, filed on Jul. 30, 2019. The contents of the application are incorporated herein by reference in their entirety.

### BACKGROUND

The present disclosure relates to an inkjet ink and an inkjet recording system.

Development in inkjet recording systems is dramatically accelerated. For example, an inkjet recording system when using photo paper as a recording medium is capable of forming high-quality images equivalent to a silver-halide photo.

Inkjet inks used in inkjet recording systems are required to enable formation of images excellent in scratch resistance. An inkjet ink using a resin emulsion has been proposed as an example of inkjet inks meeting such a demand. An inkjet ink using a resin emulsion having a specific or lower acid value is expected to enable formation of images excellent in scratch resistance.

### SUMMARY

An inkjet ink according to an aspect of the present disclosure contains pigment particles, specific resin particles, wax particles, water, and an α, ω-alkanediol having a carbon number of at least at least 3 and no greater than 5. The specific resin particles include a resin including a styrene unit. A ratio of the styrene unit to all repeating units included in the resin is at least 27% by mass and no greater than 75% by mass. The wax particles contain a polyethylene resin. The wax particles have a volume median diameter of at least 20 nm and no greater than 100 nm.

An inkjet recording system according to an aspect of the present disclosure includes a linehead and a conveyance section that conveys a recording medium. The linehead ejects the above-described inkjet ink toward the recording medium.

### BRIEF DESCRIPTION OF THE DRAWINGS

FIG. 1 is a side view of an example of an inkjet recording system.

FIG. 2 is a view of a conveyor belt, as viewed downward, of the inkjet recording system illustrated in FIG. 1.

### DESCRIPTION OF EMBODIMENTS

The following describes an embodiment of the present disclosure. Note that measurement values for volume median diameter (Dso) each are a value measured using a dynamic light scattering type particle size distribution analyzer (“ZETASIZER NANO ZS”, product of Malvern Panalytical) unless otherwise stated.

In the following description, measurement values for acid value each are a value measured in accordance with “Japanese Industrial Standards (JIS) K0070-1992” unless otherwise stated. Measurement values for mass average molecular weight (Mw) each are a value measured using gel permeation chromatography.

In the present specification, the term “(meth)acryl” may be used as a generic term for both acryl and methacryl.

### First Embodiment: Ink

The following described an inkjet ink according to a first embodiment of the present disclosure (also referred to below simply as an ink). The ink according to the present embodiment contains pigment particles, specific resin particles, wax particles, water, and an α,ω-alkanediol having a carbon number of at least 3 and no greater than 5 (also referred to below as an α,ω-alkanediol (A)). The specific resin particles contain a first resin including a styrene unit. A ratio of the styrene unit to all repeating units included in the first resin is at least 27% by mass and no greater than 75% by mass. The wax particles contain a polyethylene resin. The wax particles have a D₅₀ of at least 20 nm and no greater than 100 nm. Note that an α,ω-alkanediol is an alkanediol having a hydroxy group at both ends of a carbon main chain.

Although no particular limitations are placed on use of the ink according to the present embodiment, the ink is favorably used as an ink for an inkjet recording system including a later-described linehead.

As a result of having the above features, the ink according to the present embodiment can inhibit occurrence of nozzle clogging and enable formation of images excellent in scratch resistance and image density. The reason is presumably as follows. The ink according to the present embodiment once landing on a recording medium separates into solid components (specific examples include the pigment particles, the specific resin particles, and the wax particles) and liquid components (specific examples include the α,ω-alkanediol (A) and the water). The separated liquid components permeate throughout the recording medium. On the other hand, the separated solid components remain on the surface of the recording medium to form a film containing the pigment particles. Here, the specific resin particles contains the first resin including a styrene unit at a specific ratio, and therefore, have high hydrophobicity.

Accordingly, the specific resin particles repel the water when the ink according to the present disclosure lands on the recording medium. This prompts separation into the solid components and the liquid components. Through the prompt, the ink according to the present embodiment quickly separates into the solid components and the liquid components after landing on the recording medium. This makes the pigment particles of the ink according to the present embodiment easily remain on the surface of the recording medium, thereby achieving formation of images excellent in image density. Furthermore, the film containing the pigment particles also contains the wax particles, and therefore, is excellent in scratch resistance. That is, images formed with the ink according to the present embodiment are excellent in scratch resistance.

Typically, resin particles such as the specific resin particles and the wax particles tend to serve as a cause of nozzle clogging. However, the ink according to the present embodiment can inhibit occurrence of nozzle clogging for the following reasons. First, the wax particles, which contain a polyethylene resin, has high elasticity (low viscosity) as compared to other types of particles containing a resin (for example, polypropylene resin) other than polyethylene resins. Also, the wax particles have a relatively small particle diameter. Therefore, it is difficult for the wax particles to adhere to an inner wall of a nozzle. Furthermore, the wax particles, which have a relatively small particle diameter, are less likely to block ink from being ejected even if the wax particles adhere to the inner wall of the nozzle. The ink according to the present embodiment contains the α,ω-alkanediol (A) as a moisturizing agent. The two hydroxy groups that the α,ω-alkanediol (A) has are each bonded to a primary carbon atom, and therefore, can readily interact with water molecules. The α,ω-alkanediol (A) has a hydroxy group at each end of an alkane chain. Therefore, no local area having excessively high hydrophobicity is present in its molecule. This allows the a,w-alkanediol to exhibit high moisturizing effect. The α,ω-alkanediol (A), which has an adequately high boiling point, is less likely to dry in the nozzle. The α,ω-alkanediol (A), which has an adequately low viscosity, insignificantly increases viscosity of the ink.

From the above reasons, the ink according to the present embodiment can inhibit occurrence of nozzle clogging. The following describes the ink according to the present embodiment further in detail. Note that one of components described below may be used independently or two or more components described below may be used in combination.

[Pigment Particles]

The pigment particles in the ink according to the present embodiment are present for example in a solvent in a dispersed manner. In terms of improving color density, hue, or stability of the ink according to the present embodiment, the pigment particles have a D₅₀ of preferably at least 30 nm and no greater than 200 nm, and more preferably at least 70 nm and no greater than 130 nm.

Examples of pigments that the pigment particles may contain include yellow pigments, orange pigments, red pigments, blue pigments, violet pigments, and black pigments. Examples of the yellow pigments include C. I. Pigment Yellow (74, 93, 95, 109, 110, 120, 128, 138, 139, 151, 154, 155, 173, 180, 185, or 193). Examples of the orange pigments include C. I. Pigment Orange (32, 36, 43, 61, 63, or 71). Examples of the red pigments include C. I. Pigment Red (122 or 202). Examples of the blue pigments include C. I. Pigment Blue (15, more specifically, 15:3). Examples of the violet pigments include C. I. Pigment Violet (19, 23, or 33). Examples of the black pigments include C. I. Pigment Black (7).

In the ink according to the present embodiment, a content percentage of the pigment particles is preferably at least 1.0% by mass and no greater than 12.0% by mass, and more preferably at least 4.0% by mass and no greater than 8.0% by mass. As a result of the content percentage of the pigment particles being set to at least 1.0% by mass, image density of an image formed with the ink according to the present embodiment can be further increased. As a result of the content percentage of the pigment particles being set to no greater than 12.0% by mass, fluidity of the ink according to the present embodiment can be increased.

[Specific Resin Particles]

The specific resin particles contain the first resin including a styrene unit. The specific resin particles in the ink according to the present embodiment may be dispersed solely in a solvent. Alternatively, a later-described emulsifier may be attached to surfaces of the specific resin particles. In the above configuration, each specific resin particle and the emulsifier attached to a surface of the specific resin particle form a core-shell complex.

A ratio of the styrene unit to all repeating units included in the first resin is at least 27% by mass and no greater than 75% by mass, and preferably at least 40% by mass and no greater than 65% by mass. As a result of the ratio of the styrene unit in the first resin being set to at least 27% by mass, the ink according to the present embodiment once landing on a recording medium readily separates into the solid components and the liquid components. Therefore, images excellent in image density can be formed with the ink according to the present embodiment. As a result of the ratio of the styrene unit in the first resin being set to no greater than 75% by mass, occurrence of nozzle clogging can be inhibited.

The specific resin particles have a D₅₀ of preferably at least 115 nm and no greater than 140 nm, and more preferably at least 120 nm and no greater than 130 nm. As a result of the specific resin particles being set to have a D₅₀ of at least 115 nm, image density of an image formed with the ink according to the present embodiment can be further increased. As a result of the specific resin particles being set to have a D₅₀ of no greater than 140 nm, occurrence of nozzle clogging can be further effectively inhibited.

The first resin preferably includes, in addition to a styrene unit, a repeating unit derived from a (meth)acrylic acid alkyl ester, and further preferably includes only a styrene unit and a repeating unit derived from a (meth)acrylic acid alkyl ester. A ratio of the repeating unit derived from a (meth)acrylic acid alkyl ester to all repeating units included in the first resin is preferably at least 25% by mass and no greater than 73% by mass, and more preferably at least 35% by mass and no greater than 60% by mass.

Examples of the (meth)acrylic acid alkyl ester include methyl (meth)acrylate, ethyl (meth)acrylate, propyl (meth)acrylate, butyl (meth)acrylate, pentyl (meth)acrylate, hexyl (meth)acrylate, heptyl (meth)acrylate, and octyl (meth)acrylate. The first resin preferably includes a styrene unit, a repeating unit derived from butyl acrylate, and a repeating unit derived from methyl methacrylate.

In the ink according to the present embodiment, the content percentage of the specific resin particles is preferably at least 0.5% by mass and no greater than 4.0% by mass, and more preferably at least 1.0% by mass and no greater than 2.0% by mass. As a result of the content percentage of the specific resin particles being set to at least 0.5% by mass, image density of an image formed with the ink according to the present embodiment can be further increased. As a result of the content percentage of the specific resin particles being set to no greater than 4.0% by mass, occurrence of nozzle clogging can be further effectively inhibited.

The specific resin particles can be obtained for example through emulsion polymerization of a reaction liquid containing styrene, another monomer (for example, a (meth)acrylic acid alkyl ester), an emulsifier (for example, polyoxyethylene alkyl ether), a polymerization initiator, and water. Through such emulsion polymerization, a specific resin particle emulsion containing the specific resin particles and the emulsifier attached to surfaces of the specific resin particles can be obtained. The specific resin particle emulsion may be used directly as a raw material of the ink according to the present embodiment. Alternatively, it is possible that the specific resin particles are purified from the specific resin particle emulsion and the purified specific resin particles are used as a raw material of the ink according to the present embodiment.

The emulsion polymerization may be carried out under reaction conditions of for example a reaction temperature of 65° C. or higher and 85° C. or lower and a reaction time of 20 minutes or longer and 180 minutes or shorter. A content percentage of the monomers (styrene and other monomers) in the reaction liquid is for example at least 40.0% by mass and no greater than 60.0% by mass. A content percentage of the polymerization initiator in the reaction liquid is for example at least 0.1% by mass and no greater than 2.0% by mass. A content percentage of the emulsifier in the reaction liquid is for example at least 1.0% by mass and no greater than 6.0% by mass.

In a case where the specific resin particle emulsion is used as a raw material of the ink according to the present embodiment, the ink may contain an emulsifier derived from the specific resin particle emulsion. When the ink according to the present embodiment contains an emulsifier, the specific resin particles tend to readily disperse in the ink. A content percentage of the emulsifier in the ink according to the present embodiment is for example at least 0.03% by mass and no greater than 0.20% by mass.

[Wax Particles]

The wax particles contain a polyethylene resin. The wax particles preferably contain only a polyethylene resin. Specifically, a content percentage of the polyethylene resin in the wax particles is preferably at least 90% by mass, and more preferably 100% by mass.

The wax particles have a D₅₀ of at least 20 nm and no greater than 100 nm, and preferably at least 60 nm and no greater than 90 nm. As a result of the D₅₀ of the wax particles being set to at least 20 nm, the wax particles tend to readily disperse in the ink according to the present embodiment. As a result of the D₅₀ of the wax particles being set to no greater than 100 nm, occurrence of nozzle clogging can be inhibited.

A content percentage of the wax particles in the ink according to the present embodiment is preferably at least 0.10% by mass and no greater than 1.00% by mass, and more preferably at least 0.20% by mass and no greater than 0.40% by mass. As a result of the content percentage of the wax particles being set to at least 0.10% by mass, an image formed with the ink according to the present embodiment can have increased scratch resistance. As a result of the content of the wax particles being set to no greater than 1.00% by mass, occurrence of nozzle clogging can be further effectively inhibited.

[α,ω-Alkanediol (A)]

The α,ω-alkanediol (A) functions as a moisturizing agent. Examples of the α,ω-alkanediol (A) include 1,3-propanediol, 2-methyl-1,3-propanediol, 1,4-butanediol, and 1,5-pentanediol. As the α,ω-alkanediol (A), 1,3-propanediol, 1,4-butanediol, or 1,5-pentanediol is preferable.

Preferably, the α,ω-alkanediol (A) has a boiling point at 1 atmospheric pressure of 195° C. or higher and 210° C. or lower.

A content percentage of the α,ω-alkanediol (A) in the ink according to the present embodiment is preferably at least 3.0% by mass and no greater than 12.0% by mass, and more preferably at least 5.0% by mass and no greater than 10.0% by mass. As a result of the content percentage of the α,ω-alkanediol (A) being set to at least 3.0% by mass, occurrence of nozzle clogging can be further effectively inhibited. As a result of the content percentage of the α,ω-alkanediol (A) being set to no greater than 12.0% by mass, a situation in which the α,ω-alkanediol (A) remains in an image formed with the ink according to the present embodiment can be prevented and an image formed with the ink can have further increased scratch resistance.

[Second Resin]

Preferably, the ink according to the present embodiment further contains a second resin that is water soluble. The second resin is present in a state of being dissolved in the ink according to the present embodiment. The second resin is attached to surfaces of the pigment particles to inhibit agglomeration of the pigment particles.

Examples of the second resin include copolymers of at least one monomer out of (meth)acrylic acid alkyl esters, styrene, and vinylnaphthalene and at least one monomer out of (meth)acrylic acid and maleic acid.

A preferable second resin is a resin including a repeating unit derived from (meth)acrylic acid ((meth)acrylic acid unit), a repeating unit derived from a (meth)acrylic acid alkyl ester ((meth)acrylic acid alkyl ester unit), and a styrene unit. In a case where the second resin includes the above units, a ratio of the (meth)acrylic acid unit to all repeating units included in the second resin is preferably at least 20% by mass and no greater than 60% by mass. A ratio of the (meth)acrylic acid alkyl ester unit to all the repeating units included in the second resin is preferably at least 30% by mass and no greater than 65% by mass. A ratio of the styrene unit to all the repeating unit included in the second resin is preferably at least 5% by mass and no greater than 25% by mass. A further preferable second resin is a resin including a repeating unit derived from methacrylic acid, a repeating unit derived from methyl methacrylate, a repeating unit derived from butyl acrylate, and a styrene unit.

In a case where the ink according to the present embodiment contains the second resin, a ratio of the second resin in the ink is preferably at least 0.5% by mass and no greater than 8.0% by mass, and more preferably at least 1.5% by mass and no greater than 4.0% by mass. As a result of the content percentage of the second resin being set to no greater than 0.5% by mass, agglomeration of the pigment particles can be further effectively inhibited. As a result of the content percentage of the second resin being set to no greater than 8.0% by mass, occurrence of nozzle clogging can be further effectively inhibited.

The second resin has an acid value of for example at least 50 mgKOH/g and no greater than 150 mgKOH/g. As a result of the acid value of the second resin being set to at least 50mgKOH/g and no greater than 150mgKOH/g, agglomeration of the pigment particles can be further effectively inhibited and preservation stability of the ink according to the present embodiment can be increased.

The acid value of the second resin can be adjusted by changing the amount of a monomer used in synthesis of the second resin. For example, use of a monomer (specific examples include an acrylic acid and methacrylic acid) having an acidic functional group (for example, a carboxy group) in synthesis of the second resin can increase the acid value of the second resin.

The second resin has a Mw of for example at least 10,000 and no greater than 50,000. As a result of the Mw of the second resin being set to at least 10,000 and no greater than 50,000, an increase in viscosity of the ink according to the present embodiment can be suppressed and image density of an image formed with the ink can be increased.

The Mw of the second resin can be adjusted by changing polymerization conditions of the second resin (specific examples include an amount of a polymerization initiator, a polymerization temperature, and a polymerization time).

The amount of the polymerization initiator in polymerization of the second resin is preferably at least 0.001 mol and no greater than 5 mol relative to 1 mol of a monomer mixture, and more preferably at least 0.01 mol and no greater than 2 mol. Polymerization of the second resin can be carried out for example at a polymerization temperature of 50° C. or higher and 70° C. or lower for a polymerization time of 10 hours or longer and 24 hours or shorter. Note that the second resin thus polymerized may be directly used as a raw material of the ink according to the present embodiment, or the second resin subjected to equivalent neutralization with a base (for example, KOH) may be used as a raw material of the ink according to the present embodiment.

[Additional Moisturizing Agent]

The ink according to the present embodiment may further contain an additional moisturizing agent other than the α,ω-alkanediol (A). Examples of the additional moisturizing agent include an alkanetriol and a glycol ether.

[Water]

The water is a main solvent in the ink according to the present embodiment. A content percentage of the water in the ink according to the present embodiment is for example at least 30.0% by mass and no greater than 60.0% by mass.

[Penetrating Agent]

Preferably, the ink according to the present embodiment further contains a penetrating agent. As a result of containing a penetrating agent, the ink according to the present embodiment can have increased permeability (specifically, permeability of the liquid components in a thickness direction of a recording medium). A preferable penetrating agent is 1,2-octanediol. 1,2-Octanediol is in a liquid state at room temperature (for example, 25° C.). As such, when the ink according to the present embodiment contains 1,2-octanediol as a penetrating agent, deposition of the penetrating agent in an image formed with the ink can be inhibited.

In a case where the ink according to the present embodiment contains a penetrating agent, a content percentage of the penetrating agent in the ink is preferably at least 0.3% by mass and no greater than 1.5% by mass. As a result of the content percentage of the penetrating agent being set to at least 0.3% by mass and no greater than 1.5% by mass, permeability of the ink according to the present embodiment can be further increased.

[Surfactant]

Preferably, the ink according to the present embodiment further contains a surfactant. A surfactant can increase compatibility and dispersion stability of each component contained in the ink according to the present embodiment. A surfactant can also increase permeability (wettability) of the ink according to the present embodiment to a recording medium. A preferable example of the surfactant is a nonionic surfactant.

Preferable examples of the nonionic surfactant include ethylene oxide adducts of acetylenediols and copolymers of polyalkylene glycol alkyl ether (meth)acrylate, alkyl (meth)acrylate, polyalkylene glycol (meth)acrylate, and lauryl (meth)acrylate. Of the examples, an ethylene oxide adduct of an acetylenediol or a polyethylene glycol methyl ether, acrylate-butyl, acrylate-polypropylene glycol, acrylate-lauryl acrylate-methyl methacrylate copolymer is further preferable.

In a case where the ink according to the present embodiment contains a surfactant, a content percentage of the surfactant in the ink is preferably at least 0.2% by mass and no greater than 1.0% by mass.

[Other Components]

The ink according to the present embodiment may further contain a known additive (specific examples include a solution stabilizer, an anti-drying agent, an antioxidant, a viscosity modifier, a pH adjuster, and an antifungal agent) as necessary.

A solution stabilizer is compatibilized with each component of the ink according to the present embodiment to stabilize a solution state of the ink. Examples of the solution stabilizer include 2-pyrrolidone, N-methyl-2-pyrrolidone, and γ-butyrolactone. A preferable solution stabilizer is 2-pyrrolidone. In a case where the ink according to the present embodiment contains a solution stabilizer, a content percentage of the solution stabilizer in the ink is preferably at least 0.5% by mass and no greater than 10.0% by mass, and more preferably at least 1.5% by mass and no greater than 5.0% by mass.

A preferable example of the anti-drying agent is glycerin. In a case where the ink according to the present embodiment contains an anti-drying agent, a content percentage of the anti-drying agent in the ink is preferably at least 1.0% by mass and no greater than 15.0% by mass, and more preferably at least 3.0% by mass and no greater than 9.0% by mass.

[Ink Production Method]

The ink according to the present embodiment can be produced for example by uniformly mixing a pigment dispersion containing pigment particles, a specific resin particle emulsion containing specific resin particles, a wax containing wax particles, an a,w-alkanediol having a carbon number of at least 3 and no greater than 5, water, and any other components optionally blended depending on necessity thereof using a stirrer. In production of the ink according to the present embodiment, foreign matter and coarse particles may be removed using a filter (for example, a filter having a pore size of no greater than 5 μm) after uniform mixing of these components.

(Pigment Dispersion)

The pigment dispersion may be a dispersion containing pigment particles. A preferable example of a dispersion medium of the pigment dispersion is water. The pigment dispersion preferably contains the second resin and a surfactant in order to increase dispersibility of the pigment particles.

The pigment particles in the pigment dispersion have a D₅₀ of preferably at least 50 nm and no greater than 200 nm, and more preferably at least 80 nm and no greater than 120 nm.

A content percentage of the pigment particles in the pigment dispersion is for example at least 5.0% by mass and no greater than 25.0% by mass. In a case where the pigment dispersion contains the second resin, a content percentage of the second resin in the pigment dispersion is for example at least 2.0% by mass and no greater than 10.0% by mass. In a case where the pigment dispersion contains a surfactant, a content percentage of the surfactant in the pigment dispersion is for example at least 0.1% by mass and no greater than 2.0% by mass. A content ratio of the dispersion medium in the pigment dispersion is for example at least 60% by mass and no greater than 95% by mass.

In a case where the pigment dispersion contains the second resin, the second resin is preferably attached to surfaces of at least some of the pigment particles in the pigment dispersion.

The pigment dispersion can be prepared by wet dispersion of a pigment, a dispersion medium (for example, water), and a component optionally added depending on necessity thereof (for example, the second resin and a surfactant) using a media type wet disperser. In wet dispersion using a media type wet disperser, small-diameter beads (for example, beads having a D₅₀ of at least 0.5 mm and no greater than 1.0 mm) can for example be used as a medium. Although not particularly limited, a material of the beads is preferably a hard material (for example, glass or zirconia).

In wet dispersion using a media type wet disperser, a D₅₀ and a dispersibility of the pigment particles and a ratio of a portion of the second resin attached to the surfaces of the pigment particles to a total of the second resin can be adjusted by changing a particle diameter of the beads. Specifically, the D₅₀ of the pigment particles can be decreased as the particle diameter of the beads used is decreased. Also, the ratio of a portion of the second resin attached to the surfaces of the pigment particles to the total of the second resin can be increased as the particle diameter of the beads used is decreased.

The D₅₀ of the pigment particles in a sample can be measured for example using a dynamic light scattering type particle size distribution analyzer (“ZETASIZER NANO ZS”, product of Sysmex Corporation). Here, the sample is a solution obtained by diluting the pigment dispersion by 300 times with ion exchanged water.

In adding the pigment dispersion in production of the ink according to the present embodiment, a ratio of the pigment dispersion to all raw materials of the ink is for example at least 25.0% by mass and no greater than 60.0% by mass.

(Specific Resin Particle Emulsion)

The specific resin particle emulsion contains the specific resin particles, an emulsifier, and water. The specific resin particle emulsion can be obtained through the emulsion polymerization described in description of the specific resin particles. In adding the specific resin particle emulsion in production of the ink according to the present embodiment, a ratio of the specific resin particle emulsion to all the raw materials of the ink is for example at least 1.0% by mass and no greater than 6.0% by mass.

(Wax)

The wax contains wax particles and a dispersion medium (for example, water). A content ratio of the wax particles in the wax is for example at least 15% by mass and no greater than 40% by mass. In adding the wax in production of the ink according to the present embodiment, a ratio of the wax to all raw materials of the ink is for example at least 0.2% by mass and no greater than 2.5% by mass.

### Second Embodiment: Inkjet Recording System

The following describes an inkjet recording system according to a second embodiment of the present disclosure. An inkjet recording system according to the present embodiment includes a linehead and a conveyance section that conveys a recording medium. The linehead ejects the ink according to the first embodiment toward the recording medium. The inkjet recording system according to the present embodiment will be described below in detail with reference to the drawings. Note that the drawings are schematic illustrations that emphasize elements of configuration in order to facilitate understanding thereof, and aspects such as size and number of each element of configuration illustrated in the drawings may differ from actual ones thereof in order to facilitate preparation of the drawings.

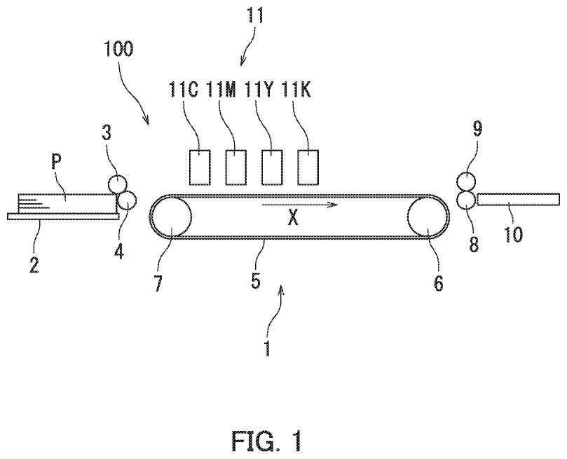

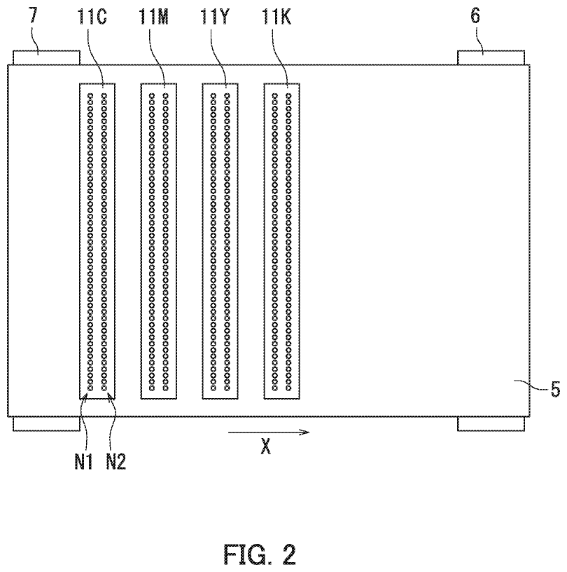

FIG. 1 is a side view illustrating a configuration of the inkjet recording system 100 that is an example of the inkjet recording system according to the present embodiment. FIG. 2 is a view of a conveyor belt 5, as viewed downward, of the inkjet recording system 100 illustrated in FIG. 1.

As illustrated in FIG. 1, the inkjet recording system 100 includes as main components a conveyance section 1 and a plurality of lineheads. The inkjet recording system 100 includes a sheet feed tray 2, a sheet feed roller 3, a feed driven roller 4, an ejection roller 8, an ejection driven roller 9, and an exit tray 10 in addition to the conveyance section 1 and the lineheads 11.

The sheet feed tray 2, the sheet feed roller 3, the feed driven roller 4, the conveyance section 1, the ejection roller 8, the ejection driven roller 9, and the exit tray 10 are arranged in the stated order from upstream to downstream in terms of a conveyance direction X of a recording medium, which is a later-described recording sheet P, (also referred to below simply as a conveyance direction X) in the inkjet recording system 100.

The sheet feed tray 2 accommodates thereon recording sheets P in a stacked manner. The sheet feed roller 3 and the feed driven roller 4 are arranged at a location adjacent to the sheet feed tray 2. The sheet feed roller 3 and the feed driven roller 4 are in contact with and pressed against each other at a location where they are opposite to each other. The sheet feed roller 3 is rotationally driven in an anticlockwise direction in FIG. 1. The feed driven roller 4 rotates following rotation of the sheet feed roller 3. Through the above rotation, the sheet feed roller 3 and the feed driven roller 4 supply the recording sheets P accommodated and stacked on the sheet feed tray 2 to the conveyance section 1 on a sheet-by-sheet basis from the topmost one of the recording sheets P.

The conveyance section 1 includes a belt drive roller 6, a belt driven roller 7, a conveyor belt 5. The belt drive roller 6 is located downstream while the belt driven roller 7 is located upstream in terms of the conveyance direction X. The conveyor belt 5 is an endless belt wound around the belt drive roller 6 and the belt driven roller 7. The belt drive roller 6 is rotationally driven in a clockwise direction in FIG. 1. Through rotation of the belt drive roller 6, the belt drive roller 6 drives the conveyor belt 5. Thus, the conveyor belt 5 conveys the recording sheet P in the conveyance direction X. The belt driven roller 7 rotates following rotation of the belt drive roller 6 through the conveyance belt 5.

The lineheads 11 are arranged above the conveyor belt 5. The lineheads 11 include a first linehead 11C, a second linehead 11M, a third linehead 11Y, and a fourth linehead 11K. The first to fourth lineheads 11C to 11K are arranged in the stated order in terms of the conveyance direction X. The first to fourth lineheads 11C to 11K are arranged at the same level in height. The first to fourth lineheads 11C to 11K are filled with respective four inks in different colors (cyan, magenta, yellow, and black). Of the four inks filled in the first to fourth lineheads 11C to 11K, at least one ink is the ink according to the first embodiment. Preferably, the four inks filled in the first to fourth lineheads 11C to 11K each are the ink according to the first embodiment. The first to fourth lineheads 11C to 11K eject the respective inks from a plurality of nozzles, which will be described later, to form an image (for example, a color image) on a recording sheet P being conveyed by the conveyor belt 5.

The ejection roller 8 and the ejection driven roller 9 are in contact with and pressed against each other at a location where they are opposite to each other. The ejection roller 8 is rotationally driven in the clockwise direction in FIG. 1. The ejection driven roller 9 rotates following rotation of the ejection roller 8. Thus, the ejection roller 8 and the ejection driven roller 9 eject the recording sheet P convened by the conveyance section 1 to the exit tray 10. The exit tray 10 receives the recording sheet P ejected.

As illustrated in FIG. 2, the first to fourth lineheads 11C to 11K each include a first nozzle row N1 and a second nozzle row N2 arranged side by side in terms of the conveyance direction X. The first and second nozzle rows N1 and N2 each include a plurality of nozzles arranged in a direction perpendicular to the conveyance direction X (also referred to below as a width direction). A length of the first and second nozzle rows N1 and N2 in the width direction (that is, a length in the width direction of an area where the first to fourth lineheads 11C to 11K are enabled to record) is longer than the length of the recording sheet P in the width direction. Accordingly, the first to fourth lineheads 11C to 11K are each enabled to record, in a secured state, an image on the recording sheet P conveyed on the conveyor belt 5. That is, the inkjet recording system 100 adopts a single path method that does not perform shuttle movement.

Typically, an inkjet recording system adopting a single path method is capable of high speed printing as a merit thereof. However, the inkjet recording system adopting the single path method does not perform overwriting unlike an inkjet recording system adopting a multi path method, and therefore, an image formed by the inkjet recording system adopting the single path method tends to have low density (copy density). The above tendency is significant when the recording medium is plain paper. In view of the foregoing, the inkjet recording system 100 uses the ink according to the first embodiment. An image excellent in image density can be formed with the ink according to the first embodiment. Accordingly, an image formed by the inkjet recording system 100 is excellent in image density even if the inkjet recording system 100 adopts a single path method.

The inkjet recording system 100, which is an example of the inkjet recording system according to the present embodiment, has been described so far with reference to the drawings. However, the inkjet recording system according to the present embodiment is not limited to the inkjet recording system 100. For example, the number of the lineheads included in the inkjet recording system according to the present embodiment may be one, two, three, five, or more. Furthermore, the inkjet recording system according to the present embodiment may be a multifunction peripheral. In the inkjet recording system according to the present embodiment, the recording medium may be made from a material other than that of the recording sheet (for example, fabric). The inkjet recording system according to the present embodiment may adopt a multi path method.

Furthermore, the number of nozzles, nozzle intervals, and a positional relationship of the nozzles of the first to fourth lineheads 11C to 11K in FIG. 2 can be appropriately set according to the specification of the apparatus.

The inkjet recording system according to the present embodiment, which includes lineheads, is capable of high-speed printing as compared to an inkjet recording system including serial heads. In the inkjet recording system according to the present embodiment, which uses the ink according to the first embodiment, occurrence of nozzle clogging can be inhibited and an image having excellent image density and excellent scratch resistance can be formed.

### EXAMPLES

The following describes Examples of the present disclosure. However, the present disclosure is not limited to Examples below.

<First Study: Specific Resin Particles>

The specific resin particles for ink use were studied in Examples first. The following describes a preparation method of each of raw materials used in ink production.

(Preparation of Second Resin)

An alkali-soluble resin including a repeating unit derived from methacrylic acid (MAA unit), a repeating unit derived from methyl methacrylate (MMA unit), a repeating unit derived from butyl acrylate (BA unit), and a repeating unit derived from styrene (ST unit) was prepared. The alkali-soluble resin had a mass average molecular weight (Mw) of 20,000 and an acid value of 100 mgKOH/g. A mass ratio of each repeating unit in the alkali-soluble resin “MAA unit: MMA unit: BA unit: ST unit” was 40:15:30:15. Then, 100 parts by mass of the alkali-soluble resin and an aqueous solution of potassium hydroxide containing 10.5 parts by mass of potassium hydroxide were mixed together. Through the above mixing, the alkali-soluble resin was neutralized with an equivalent amount (strictly, 105% amount) of KOH. Thus, a second-resin solution containing a second resin and water was obtained.

(Preparation of Pigment Dispersion)

A 0.6-L vessel was charged with a pigment (“LIONOL (registered Japanese trademark) BLUE FG-7330”, product of TOYOCOLOR CO., LTD., component: copper phthalocyanine, color index: Pigment Blue 15:3), the aforementioned second-resin solution, a surfactant (“OLFINE (registered Japanese trademark) E1010”, product of Nissin Chemical Industry Co., Ltd, ethylene oxide adduct of acetylenediol), and ion exchanged water each in an amount shown in Table 1 below. Next, the vessel contents were wet-dispersed using a media type wet disperser (DYNO (registered Japanese trademark)-MILL″, product of Willy A. Bachofen AG (WAB)).

Note that the content percentage of “Water” in Table 1 is a total content percentage of the ion exchanged water added into the vessel and water contained in the second-resin solution (specifically, water contained in the aqueous solution of potassium hydroxide used in the neutralization of the alkali-soluble resin and water as a product of the neutralization of the alkali-soluble resin and the potassium hydroxide).

TABLE 1

| Type | Content percentage [% by mass] |
|---|---|
| Pigment | 6.0 |
| Second resin | 15.0 |
| Surfactant | 0.5 |
| Water | 78.5 |
| Total | 100.0 |

Subsequently, the vessel contents were dispersed using zirconia beads (particle diameter 0.5 mm) as a medium and a wet type disperser (“NANO GRAIN MILL”, product of Asada Iron Works Co., Ltd.). The dispersion was carried out under conditions of a temperature of 10° C. and a peripheral speed of 8 m/sec. Thus, a pigment dispersion A was obtained.

The volume median diameter (D₅₀) of the pigment particles contained in the resultant pigment dispersion was measured. Specifically, the resultant pigment dispersion was diluted by 300 times with ion exchanged water and used as a measurement sample. The D₅₀ of the pigment particles in the measurement sample was measured using a dynamic light scattering type particle size distribution analyzer (“ZETASIZER NANO ZS”, product of Sysmex Corporation). The D₅₀ of the pigment particles in the measurement sample was taken to be a D₅₀ of the pigment particles contained in the pigment dispersion. The pigment particles contained in the pigment dispersion had a D₅₀ of 100 nm.

(Nonionic Surfactant)

A copolymer including a repeating unit derived from polyethylene glycol methyl ether acrylate (PEGA unit), a repeating unit derived from butyl acrylate (BA unit), a repeating unit derived from polypropylene glycol acrylate (PPGA unit), a repeating unit derived from lauryl acrylate (LA unit), and a repeating unit derived from methyl methacrylate (MMA unit) was used as a nonionic surfactant. A mass ratio of the repeating units in the copolymer (PEGA unit: BA unit: PPGA unit: LA unit: MMA unit) was 60:10:10:12:8.

The nonionic surfactant had a surface tension of 30.5 mN/m and a Mw of 5,000. The nonionic surfactant was water-soluble. Note that the surface tension of the nonionic surfactant was measured by the Wilhelmy method at a liquid temperature of 25° C. using a surface tension meter (“CBVP-Z”, product of Kyowa Interface Science Co., Ltd.).

The Mw of the nonionic surfactant was measured under the following conditions using a gel permeation chromatography (HLC-8020GPC″, product of Tosoh Corporation). A calibration curve was plotted using n-propylbenzene and F-40, F-20, F-4, F-1, A-5000, A-2500, and A-1000 each being a TSKgel standard polystyrene produced by Tosoh Corporation.

(Measurement Conditions for Mass Average Molecular Weight)

Column: “TSKgel SUPER MULTIPORE HZ-H”, product of Tosoh Corporation (semi-micron column having a size of 4.6 mm I.D.×15 cm)

Number of columns: 3

Eluent: tetrahydrofuran

Flow rate: 0.35 mL/min.

Sample injection amount: 10 μL

Measurement Temperature: 40° C.

Detector: IR detector

(Preparation of Specific Resin Particles)

Ion exchanged water was bubbled (deoxidized) using nitrogen gas. A flask was charged with 44.5 g of the deoxidized ion exchanged water. Next, the temperature of the flask content was increased to 60° C. After the temperature increase, 0.5 g of 2,2′-azobis[2-(2-imidazoline-2-yl)propane] as a polymerization initiator was added into the flask. The temperature of the flask contents was then increased to 63° C. After the temperature increase, 5.0 g of an emulsifier (“EMULGEN (registered Japanese trademark) 1135S-70”, product of Kao Corporation, effective component: polyoxyethylene alkyl ether, effective component concentration: 70% by mass) was added into the flask to dissolve the emulsifier in the ion exchanged water over 60 minutes. The temperature of the flask contents was then increased to 65° C. After the temperature increase, styrene, butyl acrylate, and methyl methacrylate each being a monomer of 50.0 g in total were added into the flask. A mass ratio of the respective monomers was as indicated in Table 2 below. Thereafter, the temperature of the flask contents was increased to 75° C. After the temperature increase, the flask contents were caused to react (emulsion polymerization) at 75° C. for 60 minutes. After the reaction, the flask contents were cooled to room temperature. Through the above processes, a specific resin particle emulsion (specifically, any of specific resin particle emulsions (E-1) to (E-7)) containing the specific resin particles (specifically, corresponding one type of specific resin particles (R-1) to (R-7)) were obtained. The specific resin particle emulsions (E-1) to (E-7) each had a content percentage of the specific resin particles of 50.0% by mass and a content percentage of the emulsifier of 3.5% by mass.

A D₅₀ of the specific resin particles (specifically one type of the specific resin particles (R-1) to (R-7)) included in the resultant specific resin particle emulsion was measured according to the same method as that for measuring the D₅₀ of the pigment particles contained in the pigment dispersion. Measurement results are shown in Table 2.

TABLE 2

| Specific resin particle emulsion | | | E-1 | E-2 | E-3 | E-4 | E-5 | E-6 | E-7 |
|---|---|---|---|---|---|---|---|---|---|
| Specific | Type | | R-1 | R-2 | R-3 | R-4 | R-5 | R-6 | R-7 |
| resin | Monomer | Styrene | 0 | 25 | 40 | 50 | 60 | 70 | 80 |
| particles | [% by | Butyl acrylate | 50 | 60 | 45 | 30 | 20 | 10 | 10 |
| | mass] | Methyl methacrylate | 50 | 15 | 15 | 20 | 20 | 20 | 10 |

| | | | | | | | |
|---|---|---|---|---|---|---|---|
| D₅₀ [nm] | 110 | 105 | 130 | 120 | 123 | 125 | 143 |

[Ink Production]

Inks (A-1) to (A-7) were produced according to the following method.

Ion exchanged water was added into a vessel equipped with a stirrer (“THREE-ONE MOTOR (registered Japanese trademark) BL-600”, product of Shinto Scientific Co., Ltd.). Under stirring of the content by the stirrer (stirring speed: 400 rpm), the aforementioned pigment dispersion, the specific resin particle emulsion (specifically, any of the specific resin particle emulsions (E-1) to (E-7)), a wax containing wax particles (a later-described wax (W-3), “S111”, product of Mitsui Chemicals, Inc.), a later-described moisturizing agent (M-1) (1,3-propanediol that is an α,ω-alkanediol), 2-pyrrolidone, the aforementioned nonionic surfactant, 1,2-octanediol, and glycerin were added into the vessel in the stated order. The ratio of amounts of the added raw materials was set as shown in Table 3 below. The types of the added specific resin particle emulsion were set as shown in Table 4 below. Note that 2-pyrrolidone, 1,2-octanediol, and glycerin were used as a solution stabilizer, a penetrating agent, and an anti-drying agent, respectively.

TABLE 3

| Raw material | Amount [% by mass] |
|---|---|
| Pigment dispersion | 40.0 |
| Specific resin particle emulsion | 3.0 |
| Wax (W-3) | 1.0 |
| Moisturizing agent (M-1) | 7.0 |
| 2-Pyrrolidone | 2.5 |
| Nonionic surfactant | 0.5 |
| 1,2-Octanediol | 0.7 |
| Glycerin | 6.0 |
| Ion exchanged water | Remainder |
| Total | 100.0 |

The resultant mixed liquid was filtered using a filter having a pore size of 5 μm in order to remove foreign matter and coarse particles from the mixed liquid. Through the above, an ink (specifically, each of the inks (A-1) to (A-7)) was obtained.

[Evaluation]

With respect to each of the inks (A-1) to (A-7) obtained as above, image density and scratch resistance of an image formed with the ink and nozzle clogging were evaluated. Measurement results are shown in Table 4 below.

(Image Density)

An inkjet recording apparatus (prototype produced by KYOCERA Document Solutions Inc.) having the same configuration as the inkjet recording system 100 illustrated in FIGS. 1 and 2 was used as an evaluation apparatus. Any of the inks (A-1) to (A-7) was set in the first linehead 11C of the evaluation apparatus. Subsequently, a solid image having a size of 10 cm×10 cm was formed on a sheet of A4-size plain paper (“C²”, product of Fuji Xerox Co., Ltd., plain paper copier (PPC) paper) using the evaluation apparatus under environmental conditions of a temperature of 25° C. and a relative humidity of 60% (a solid image formation test). In the image formation, a volume of each of ink droplets ejected from recording heads of the evaluation apparatus was set to 11 μL.

The plain paper with the solid image formed thereon was left to stand for 1 hour in an environment at a temperature of 25° C. and a relative humidity of 60%.

Thereafter, an image density of the formed solid image was measured using a reflectance densitometer (“RD-19”, product of X-Rite Inc.). Specifically, image densities of 10 locations randomly selected in the solid image were measured. An arithmetic mean of the measured 10 image densities was taken to be an evaluation value for image density. An image density having an evaluation value of at least 1.30 can be evaluated as good, and an image density having an evaluation value of less than 1.30 can be evaluated as poor.

(Nozzle Clogging)

After the solid image formation test, nozzles of the evaluation apparatus were cleaned using a nozzle cleaning function that the evaluation apparatus had under environmental conditions of a temperature of 25° C. and a relative humidity of 10%. Specifically, 3 mL of the ink was purged from the nozzles of the evaluation apparatus to refresh the inside of the nozzles, and then, ink attached to the tip ends of the nozzles was wiped off using a wiping function that the evaluation apparatus had. The evaluation apparatus was then left to stand for 1 hour in an environment at a temperature of 25° C. and a relative humidity of 10%. Thereafter, a solid image was formed using the evaluation apparatus according to the same method as that in the solid image formation test. In this solid image formation, it is evaluated that occurrence of nozzle clogging was inhibited with an ink (nozzle clogging “A”) when no nozzle clogging with the ink had occurred in the evaluation apparatus. By contrast, it is evaluated that occurrence of nozzle clogging was not inhibited with an ink (nozzle clogging “B”) when nozzle clogging with the ink had occurred in the evaluation apparatus.

(Scratch Resistance)

A solid image having a size of 10 cm×10 cm was formed on a sheet of A4-size multi-purpose printer paper (“VITALITY”, product of Fuji Xerox Co., Ltd., moisture content: 4% by mass to 6% by mass) using the evaluation apparatus under environmental conditions of a temperature of 28° C. and a relative humidity of 80%. In this image formation, a volume of each of ink droplets ejected from the recording heads was set to 11 pL.

After a 10-second lapse from the solid image formation, a sheet of test paper (unused sheet of the aforementioned multi-purpose printer paper) was put on a surface (a side with the solid image formed thereon) of the sheet of the multi-purpose printer paper on which the solid image had been formed. The solid imaged was rubbed back and forth 5 times with one of the sides of the test paper with a load of 1 kg applied to the test paper using a weight. Then, an image density of the side of the test paper was measured using the aforementioned reflectance densitometer. Specifically, image densities of 10 locations randomly selected on the side of the test paper were measured.

An arithmetic mean of the measured 10 image densities was taken to be an evaluation value for scratch resistance. A scratch resistance having an evaluation value of no greater than 0.02 was evaluated as good (A), and a scratch resistance having an evaluation value of greater than 0.02 was evaluated as poor (B).

TABLE 4

| Ink | | A-1 | A-2 | A-3 | A-4 | A-5 | A-6 | A-7 |
|---|---|---|---|---|---|---|---|---|
| Specific resin | | E-1 | E-2 | E-3 | E-4 | E-5 | E-6 | E-7 |
| particle emulsion | | | | | | | | |
| Evaluation | Image | 1.26 | 1.28 | 1.32 | 1.34 | 1.35 | 1.36 | 1.38 |
| | density | | | | | | | |
| | Nozzle | A | A | A | A | A | A | B |
| | clogging | | | | | | | |
| | Scratch | B | A | A | A | A | A | A |
| | resistance | | | | | | | |

As shown in Tables 2 and 4, the inks (A-3) to (A-6) each contained specific resin particles containing a first resin including a styrene unit. In each of the inks (A-3) to (A-6), a ratio of the styrene unit to all repeating units included in the first resin was at least 27% by mass and no greater than 75% by mass. Each of the inks (A-3) to (A-6) inhibited occurrence of nozzle clogging, and scratch resistance and image density of the image formed with the ink were evaluated as good.

By contrast, the ink (A-1) contained a first resin that included no styrene unit. In the ink (A-2), a ratio of the styrene unit to all repeating units included in the first resin was less than 27% by mass. The image density of the image formed with any of the inks (A-1) and (A-2) was evaluate as poor. Furthermore, scratch resistance of the image formed with the ink (A-1) was evaluated as poor. This is thought to be because the specific resin particles, which have low hydrophobicity, insufficiently exhibit an effect of causing the pigment particles to stay on a recording medium after the ink lands on the recording medium.

In the ink (A-7), the ratio of the styrene unit to all repeating units included in the first resin exceeds 75% by mass. Occurrence of nozzle clogging was not inhibited with the ink (A-7). This is thought to be because the specific resin particles, which have excessively high hydrophobicity, encourage drying of an ink when the ink remains in the nozzles.

<Second Study: Wax Particles>

Wax particles for ink use were studied next.

[Wax Particles]

Waxes (W-1) to (W-5) shown in Table 5 below were each prepared as a wax containing wax particles. A polyethylene resin contained in the wax (W-4) was a polyethylene resin obtained by decomposing a polyethylene resin contained in the wax (W-3) into low molecules. Note that “®”, “PE”, and “EB” in Table 5 represent “registered Japanese trademark”, “polyethylene resin”, and “ethylene-butene copolymer”, respectively.

TABLE 5

| | | | | D₅₀ | Solid content |
|---|---|---|---|---|---|
| Wax | Product name | Manufacturer | Wax particles | [nm] | [% by mass] |
| W-1 | CHEMIPERL ® W4005 | Mitsui Chemicals, Inc. | PE | 200 | 30 |
| W-2 | AQUACER ® 531 | BYK Japan K.K. | PE | 130 | 30 |
| W-3 | S111 | Mitsui Chemicals, Inc. | PE | 70 | 27 |
| W-4 | S120 | Mitsui Chemicals, Inc. | PE | 80 | 27 |
| W-5 | CHEMIPERL ® A-100 | Mitsui Chemicals, Inc. | EB | 2000 | 30 |

[Ink Production]

Inks (A-8) to (A-12) were produced according to the following method.

Ion exchanged water was added into a vessel equipped with a stirrer (“THREE-ONE MOTOR (registered Japanese trademark) BL-600”, product of Shinto Scientific Co., Ltd.). Under stirring of the content by the stirrer (stirring speed: 400 rpm), the aforementioned pigment dispersion, the specific resin particle emulsion (E-3), a wax containing wax particles (specifically, any of the waxes (W-1) to (W-5)), a later-described moisturizing agent (M-2) (1,4-butanediol that is an α,ω-alkanediol), 2-pyrrolidone, the aforementioned nonionic surfactant, 1,2-octanediol, and glycerin were added into the vessel in the stated order. The ratio of amounts of the added raw materials was set as shown in Table 6 below.

TABLE 6

| Material | Amount [% by mass] |
|---|---|
| Pigment dispersion | 40.0 |
| Specific resin particle emulsion (E-3) | 3.0 |
| Wax | 1.0 |
| Moisturizing agent (M-2) | 7.0 |
| 2-Pyrrolidone | 2.5 |
| Nonionic surfactant | 0.5 |
| 1,2-Octanediol | 0.7 |
| Glycerin | 6.0 |
| Ion exchanged water | Remainder |
| Total | 100.0 |

The resultant mixed liquid was filtered using a filter having a pore size of 5 μm in order to remove foreign matter and coarse particles from the mixed liquid. Through the above, an ink (specifically, each of the inks (A-8) to (A-12)) was obtained.

[Evaluation]

With respect to each of the inks (A-8) to (A-12) obtained as above, image density and scratch resistance of an image formed with the ink and nozzle clogging were evaluated according to the same methods as those according to which the inks (A-1) to (A-7). Measurement results are shown in Table 7 below.

TABLE 7

| Ink | | A-8 | A-9 | A-10 | A-11 | A-12 |
|---|---|---|---|---|---|---|
| Wax | | W-1 | W-2 | W-3 | W-4 | W-5 |
| Evaluation | Image density | 1.31 | 1.31 | 1.31 | 1.31 | 1.33 |
| | Nozzle clogging | B | B | A | A | B |
| | Scratch resistance | A | A | A | A | A |

As shown in Tables 5 and 7, the inks (A-10) and (A-11) each contained wax particles containing a polyethylene resin and having a D₅₀ of at least 20 nm and no greater than 100 nm. Each of the inks (A-10) and (A-11) inhibited occurrence of nozzle clogging, and scratch resistance and image density of an image formed with the ink were evaluated as good.

By contrast, the wax particles contained in each of the inks (A-8) and (A-9) had a D₅₀ of greater than 100 nm. The wax particles contained in the ink (A-12) had a D₅₀ of greater than 100 nm and contained no polyethylene resin. Each of the inks (A-8), (A-9), and (A-12) did not inhibit occurrence of nozzle clogging. This is thought to be because wax particles having a larger particle diameter and wax particles containing a resin other than a polyethylene resin encourage occurrence of nozzle clogging.

<Study 3: Moisturizing Agent>

Moisturizing agents for ink use were studied next.

[Moisturizing Agent]

Moisturizing agents (M-1) to (M-9) shown in Table 8 below were each prepared as a moisturizing agent. Of the moisturizing agents (M-1) to (M-9), the moisturizing agents (M-1) to (M-3) each were an α,ω-alkanediol having a carbon number of at least 3 and no greater than 5. Not that “Boiling point” in Table 8 refers to a boiling point at 1 atm. “∞” under solubility in water indicates mixing with water at any rate.

TABLE 8

| | | Boiling | | Solubility |
|---|---|---|---|---|
| Moisturizing | Name of | point | Carbon | in water |
| agent | compound | [° C.] | number | [g/100 g of water] |
| M-1 | 1,3-Propanediol, | 207 | 3 | ∞ |
| M-2 | 1,4-Butanediol | 204 | 4 | ∞ |
| M-3 | 1,5-Pentanediol | 197 | 5 | ∞ |
| M-4 | 1,2-Pentanediol | 206 | 5 | ∞ |
| M-5 | 1,3-Butanediol | 207 | 4 | ∞ |
| M-6 | 1,2-Butanediol | 193 | 4 | ∞ |
| M-7 | 1,2-Propanediol, | 188 | 3 | ∞ |
| M-8 | Ethylene glycol | 190 | 2 | ∞ |
| M-9 | 1,6-Pentanediol | 230 | 6 | ∞ |

[Ink Production]

Inks (A-13) to (A-21) were produced according to the following method.

Ion exchanged water was added into a vessel equipped with a stirrer (“THREE-ONE MOTOR (registered Japanese trademark) BL-600”, product of Shinto Scientific Co., Ltd.). Under stirring of the content by the stirrer (stirring speed: 400 rpm), the aforementioned pigment dispersion, the specific resin particle emulsion (E-3), a wax (W-4) containing wax particles, a moisturizing agent (specifically, any of the moisturizing agents (M-1) to (M-9)), 2-pyrrolidone, the aforementioned nonionic surfactant, 1,2-octanediol, and glycerin were added into the vessel in the stated order.

The ratio of amounts of the added materials was set as shown in Table 9 below.

TABLE 9

| Material | Amount [% by mass] |
|---|---|
| Pigment dispersion | 40.0 |
| Specific resin particle emulsion (E-3) | 3.0 |
| Wax (W-4) | 1.0 |
| Moisturizing agent | 7.0 |
| 2-Pyrrolidone | 2.5 |
| Nonionic surfactant | 0.5 |
| 1,2-Octanediol | 0.7 |
| Glycerin | 6.0 |
| Ion exchanged water | Remainder |
| Total | 100.0 |

The resultant mixed liquid was filtered using a filter having a pore size of 5 μm in order to remove foreign matter and coarse particles from the mixed liquid. Through the above, an ink (specifically, each of the inks (A-13) to (A-21)) was obtained.

[Evaluation]

With respect to each of the inks (A-13) to (A-21) obtained as above, image density and scratch resistance of an image formed with the ink and nozzle clogging were evaluated according to the same methods as those according to which the inks (A-1) to (A-7). Measurement results are shown in Table 10 below.

TABLE 10

| Ink | | A-13 | A-14 | A-15 | A-16 | A-17 | A-18 | A-19 | A-20 | A-21 |
|---|---|---|---|---|---|---|---|---|---|---|
| Moisturizing agent | | M-1 | M-2 | M-3 | M-4 | M-5 | M-6 | M-7 | M-8 | M-9 |
| Evaluation | Image density | 1.31 | 1.32 | 1.31 | 1.32 | 1.31 | 1.31 | 1.31 | 1.31 | 1.32 |
| | Nozzle clogging | A | A | A | B | B | B | B | B | A |
| | Scratch resistance | A | A | A | A | A | A | A | A | B |

As shown in Tables 8 and 10, the inks (A-13) to (A-15) each contained the α,ω-alkanediol (A) as a moisturizing agent. Each of the inks (A-13) to (A-15) inhibited occurrence of nozzle clogging, and image density and scratch resistance of an image formed with the ink were evaluated as good.

By contrast, the moisturizing agents contained in the inks (A-16) to (A-19) each were an alkanediol that is not equivalent to an α,ω-alkanediol. Each of the inks (A-16) to (A-19) did not inhibit occurrence of nozzle clogging. This is thought to be because an alkanediol that is not equivalent to an α,ω-alkanediol has lower moisturizing action than the α,ω-alkanediol.

The moisturizing agent contained in the ink (A-20) was an α,ω-alkanediol having a carbon number of less than 3. Occurrence of nozzle clogging was not inhibited with the ink (A-20). This is thought to be because the α,ω-alkanediol having a carbon number of less than 3 has a low boiling point and at least a portion of the α,ω-alkanediol evaporates in the nozzles, thereby allowing insufficient exhibition of its moisturizing action.

The moisturizing agent contained in the ink (A-21) was an α,ω-alkanediol having a carbon number of greater than 5. Scratch resistance of an image formed with the ink (A-21) was evaluated as poor. This is thought to be because the α,ω-alkanediol having a carbon number of greater than 5 has a high boiling point, and accordingly, continued remaining on the formed image to impair scratch resistance.

As described above, the inks (A-3) to (A-6), (A-10), (A-11), and (A-13) to (A-15) each contained pigment particles, specific resin particles, wax particles, the α,ω-alkanediol (A), and water. The specific resin particles contained a first resin including a styrene unit. A ratio of the styrene unit to all repeating units included in the first resin was at least 27% by mass and no greater than 75% by mass. The wax particles contained a polyethylene resin. The wax particles had a volume median diameter of at least 20 nm and no greater than 100 nm. Each of the inks (A-3) to (A-6), (A-10), (A-11), and (A-13) to (A-15) inhibited occurrence of nozzle clogging and an image excellent in scratch resistance and image density was formed with the ink.

What is claimed is:

1. An inkjet ink comprising:
pigment particles, specific resin particles, wax particles, water, and an α,ω-alkanediol having a carbon number of at least 3 and no greater than 5, wherein
the specific resin particles contain a first resin including a styrene unit,
a ratio of the styrene unit to all repeating units included in the first resin is at least 27% by mass and no greater than 75% by mass,
the wax particles contain a polyethylene resin, and
the wax particles have a volume median diameter of at least 20 nm and no greater than 100 nm.

2. The inkjet ink according to claim 1, further comprising
a second resin that is water soluble, wherein
the second resin includes a repeating unit derived from (meth)acrylic acid, a repeating unit derived from a (meth)acrylic acid alkyl ester, and a styrene unit.

3. The inkjet ink according to claim 1, wherein
the specific resin particles have a volume median diameter of at least 115 nm and no greater than 140 nm.

4. The inkjet ink according to claim 1, wherein
a content percentage of the specific resin particles in the ink is at least 0.5% by mass and no greater than 4.0% by mass.

5. The inkjet ink according to claim 1, wherein
a content percentage of the wax particles in the ink is at least 0.10% by mass and no greater than 1.00% by mass.

6. The inkjet ink according to claim 1, wherein
a content ratio of the α,ω-alkanediol having a carbon number of at least 3 and no greater than 5 in the ink is at least 3.0% by mass and no greater than 12.0% by mass.

7. An inkjet recording system comprising:
a conveyance section configured to convey a recording medium; and
a linehead, wherein
the linehead ejects the inkjet ink according to claim 1 toward the recording medium.
